(19) United States
(12) Patent Application Publication
(10) Pub. No.: US 2020/0208974 A1
(43) Pub. Date: Jul. 2, 2020

(54) GYROSCOPE

(71) Applicant: AAC Acoustic Technologies (Shenzhen) Co., Ltd., Shenzhen (CN)

(72) Inventors: Zhenkui Meng, Shenzhen (CN); Yuwei Liu, Cavendish (SG)

(21) Appl. No.: 16/708,435

(22) Filed: Dec. 10, 2019

(30) Foreign Application Priority Data
Dec. 30, 2018 (CN) 201811648843.7

(51) Int. Cl. G01C 19/5712

(52) U.S. Cl. CPC G01C 19/5712

(57) ABSTRACT

A gyroscope is provided. The gyroscope includes a fixing frame and a vibration unit accommodated in the fixing frame. The vibration unit includes a weight and a connection frame surrounding the weight. The gyroscope further includes a first connection member connecting the vibration unit and the fixing frame and a second connection member connecting the weight and the connection frame, in such a manner that the vibration unit rotates about the first connection member as a central axis and the weight rotates about the second connection member as a central axis.

### TECHNICAL FIELD

The present invention relates to a field of a rotation sensitive device using a vibration member, such as a field of a vibration angular velocity sensor (G01C19/56) based on the Coriolis force, and in particular, to a gyroscope.

### BACKGROUND

A MEMS gyroscope is a micro-electromechanical system gyroscope. MEMS (Micro-Electro-Mechanical Systems) is a whole micro-electromechanical system that integrates mechanical elements, micro-sensors, micro-actuators, circuits for signal processing and control, interface circuits, communications, and power supplies.

Moreover, the accuracy of structures of gyroscopes in terms of rotation detection is not high enough, therefore it is necessary to provide a gyroscope capable of performing a rotation measurement with a high accuracy.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a front view of a gyroscope;

FIG. 2 is a perspective schematic view of a; and

FIG. 3 is an enlarged view of structures in region A shown in FIG. 2.

### REFERENCE SIGNS

1—fixing frame, 2—connection frame, 21—second connection plate, 22—second movable electrode plate, 3—weight, 31—first connection plate, 32—first movable electrode plate, 4—first connection member, 5—second connection member, 6—first fixed electrode plate, and 7—second fixed electrode plate.

### DESCRIPTION OF EMBODIMENTS

The present invention will be further illustrated with reference to the accompanying drawings and the embodiments.

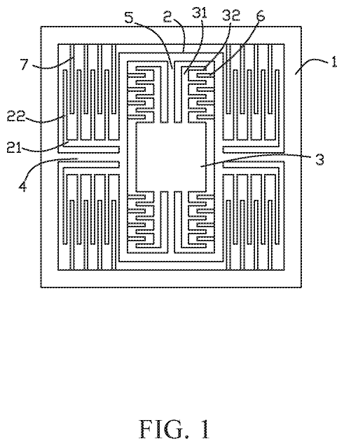

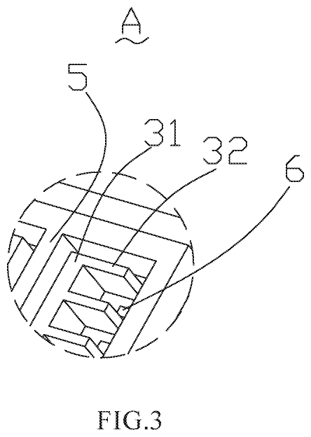

As shown in FIGS. 1-3, according to an embodiment of the present invention, a gyroscope includes a fixing frame 1 and a vibration unit accommodated in the fixing frame 1. The vibration unit includes a weight 3 and a connection frame 2 surrounding the weight 3. The gyroscope further includes a first connection member 4 that connects the vibration unit and the fixing frame 1, and a second connection member 5 that connects the weight 3 and the connection frame 2, so that the vibration unit is rotated about the first connection member 4 as a central axis, and the weight 3 is rotated about the second connection member 5 as a central axis. The first connection member 4 extends in a direction perpendicular to a direction in which the second connection member 5 extends. Optionally, each of two opposite sides of the vibration unit is fixed to the fixing frame 1 through the first connection member 4, and each of two opposite sides of the weight 3 is fixed to the connection frame 2 through the second connection member 5. Such a structure as described above enables the weight 3 to have a smaller rotational resistance when rotating, so that it is possible to have a larger rotation angle. When the structure rotates, rotations in two directions are generated, one is a rotation about a straight line where the first connection member 4 is located as a rotation axis, and the other is a rotation about a straight line where the second connection member 5 is located as a rotation axis. Between the weight 3 and the connection frame 2, since the connection frame 2 and the fixing frame 1 are connected through a connection member, so that a degree of freedom of the other rotational direction is relatively large. In an embodiment, the connector is optionally provided as an elastic member or an elastic beam. However, besides a connection through the elastic member and the elastic beam, connection can be realized through other members being capable of realizing an automatic rotation between the connection frame 2 and the fixing frame 1.

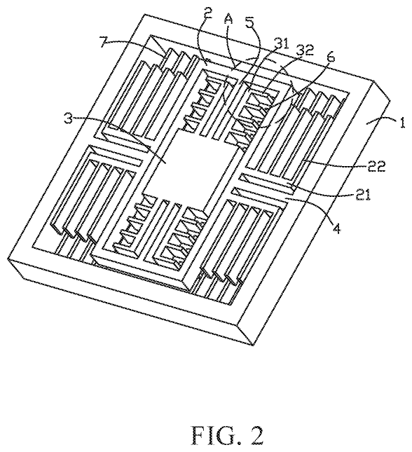

In an embodiment, an arrangement and an installment of the electrode plates is as follows. As shown in FIG. 2, the vibration unit includes second connection plates 21, second movable electrode plates 22 and second fixed electrode plates 7. The second connection plates 21 extend from two sides of the connection frame 2 in a direction parallel with a direction in which the first connection member 4 extends. The second movable electrode plates 22 extend from a side of the second connection plate 21 and are arranged in a shape of a comb. The second fixed electrode plate 7 extends from the fixing frame 1 and is arranged to be parallel with the second movable electrode plate 22 in a one-to-one correspondence. Each of two sides of the first connection member 4 is provided with the second connection plate 21 and the second movable electrode plate 22.

The vibration unit includes a first connection plate 31 extending from one side of the weight 3, and first movable electrode plates 32 extending from one side of the first connection plate 31 and arranged in a shape of a comb. The first movable electrode plate 32 is parallel with a direction in which the second connection member 5 extends. The vibration unit further includes first fixed electrode plates 6 extending from the connection frame 2 and arranged to be parallel with the first movable electrode plate 32 in a one-to-one correspondence. Each of two sides of the second connection member 5 is provided with a first connection plate 31 and a first movable electrode plate 32. The second fixed electrode plate 7 and the first fixed electrode plate 6 can be directly arranged at a corresponding position of the fixing frame 1. Alternatively, one part of each of the second fixed electrode plate 7 and the first fixed electrode plate 6 can be arranged at the fixing frame 1, and the other part of each of the second fixed electrode plate 7 and the first fixed electrode plate 6 can be arranged in a relatively fixed location with respect to a movable electrode through other components. A structure is as shown in FIG. 2 where the second movable electrode plate 22 is arranged in a rectangular shape and is parallel with a length direction of the second connection member 5, and the first movable electrode plate 32 is arranged in a square shape and is parallel with a length direction of the first connection member 4. A purpose of such arrangement is to be completed according to its structure, so that more electrode plates can be accommodated in a space. Moreover, the movable electrode plate mentioned in this embodiment is named because it can follow a movement of the weight 3.

When the gyroscope rotates irregularly, that is, when the gyroscope rotates in two rotation directions, since the second movable electrode plate 22 and the first movable electrode plate 32 directly or indirectly connected to the weight 3 and the connection frame 2, at this time, the weight 3 and the connection frame 2 each rotate, the first movable electrode plate 32 and the second movable electrode plate 22 are brought to move relative to the first fixed electrode plate 6 and the second fixed electrode plate 7, respectively. Since fixed electrode plates of the gyroscope are stationary with respect to each other, at this time, an opposite area between the second movable electrode plate 22 and the second fixed electrode plate 7 is changed, that is, a capacitance area of a peripheral capacitor plate is changed, so that a change of electric quantity is output. An opposite area between the first movable electrode plate 32 and the first fixed electrode plate 6 is changed, that is, a capacitance area of a periphery of the weight 3 is changed, so that a change of electric quantity is output. The situation of a rotation of the gyroscope can be calculated by obtaining the two changes of electric quantity.

The above are only optional embodiments of the present invention. Here, it should be noted that those skilled in the art can make modifications without departing from the inventive concept of the present invention, but these modifications shall fall into the protection scope of the present invention.

What is claimed is:

1. A gyroscope, comprising:
a fixing frame;
a vibration unit accommodated in the fixing frame and comprising a weight and a connection frame surrounding the weight;
a first connection member; and
a second connection member,
wherein the first connection member connects the vibration unit with the fixing frame and the second connection member connects the weight and the connection frame, in such a manner that the vibration unit rotates about the first connection member as a central axis and the weight rotates about the second connection member as a central axis.

2. The gyroscope as described in claim 1, wherein each of two opposite sides of the vibration unit is fixed to the fixing frame through the first connection member, and each of two opposite sides of the weight is fixed to the connection frame through the second connection member.

3. The gyroscope as described in claim 1, wherein the first connection member and the second connection member each are an elastic member.

4. The gyroscope as described in claim 1, wherein the first connection member extends in a direction perpendicular to a direction in which the second connection member extends.

5. The gyroscope as described in claim 1, wherein the vibration unit comprises:
a first connection plate extending from the weight along a direction parallel with a direction in which the second connection member extends, wherein the first connection plate is provided with a plurality of first movable electrode plates; and
a plurality of first fixed electrode plates extending from the connection frame and arranged to be parallel with the plurality of first movable electrodes plates in a one-to-one correspondence.

6. The gyroscope as described in claim 5, wherein each of two sides of the second connection member is provided with the first connection plate and at least two first movable electrode plates of the plurality of first movable electrode plates, and the at least two first movable electrode plates are in a shape of a comb.

7. The gyroscope as described in claim 1, further comprising:
a second connection plate extending from the connection frame in a direction parallel with a direction in which the first connection member extends, wherein the second connection plate is provided with a plurality of second movable electrode plates; and
a plurality of second fixed electrode plates extending from the fixing frame and arranged to be parallel with the plurality of second movable electrode plates in a one-to-one correspondence.

8. The gyroscope as described in claim 7, wherein each of two sides of the first connection member is provided with the second connection plate and at least two second movable electrode plates of the plurality of second movable electrode plates, and the at least two second movable electrode plates are in a shape of a comb.

9. The gyroscope as described in claim 1, wherein the weight is a square weight.

10. The gyroscope as described in claim 2, wherein the weight is a square weight.

11. The gyroscope as described in claim 3, wherein the weight is a square weight.

12. The gyroscope as described in claim 4, wherein the weight is a square weight.

13. The gyroscope as described in claim 5, wherein the weight is a square weight.

14. The gyroscope as described in claim 6, wherein the weight is a square weight.

15. The gyroscope as described in claim 7, wherein the weight is a square weight.

16. The gyroscope as described in claim 8, wherein the weight is a square weight.

17. The gyroscope as described in claim 8, wherein the connection frame is of a rectangular shape, and has a long-side direction same as a length direction of the second connection member, and the fixing frame is of a square shape.
